(19) United States
(12) Patent Application Publication
(10) Pub. No.: US 2009/0045189 A1
(43) Pub. Date: Feb. 19, 2009

(54) MICROWAVEABLE PACKAGE

(75) Inventors: Dwayne Cormier, Nova Scotia (CA); Dawn MacDonald, Amherst (CA)

Correspondence Address: BAKER & DANIELS LLP;111 E. WAYNE STREET, SUITE 800, FORT WAYNE, IN, 46802, US

(73) Assignee: EPC Industries Limited d/b/a as Polycello (a Division of EPC Industries Limited), Amherst (CA)

(21) Appl. No.: 12/192,381

(22) Filed: Aug. 15, 2008

(30) Foreign Application Priority Data
Aug. 17, 2007 (CA) 2597828

(51) Int. Cl. H05B 6/80

(52) U.S. Cl. 219/727

(57) ABSTRACT

A package for containing food to be heated in a microwave oven, including laminates that form the package and contain apertures for venting steam or pressure from within the package.

### FIELD OF THE INVENTION

The present invention relates to the field of packaging for food items where the fresh or frozen packaged food items can be cooked or heated in a microwave oven.

### BACKGROUND OF THE INVENTION

Food items are frequently sold to consumers in packages that are also intended to contain the food items during cooking. Some of these packages are designed to be used in microwave ovens, which provides the consumer with the convenience of being able to insert the packaged food, as purchased, directly into the microwave oven, without the necessity of using any other cooking container.

Difficulties arise with many prior food packages, since they are sometimes difficult to open, or the packages leak fluids and water from openings during the heating or cooking process.

In Canadian Patent No. 2,419,614 entitled “Packaging Material and Packaging Product”, packaging material is described as being suitable to make a bag for heating food in a microwave oven. This packaging material is modified by using a heat sealing agent with a low melting point applied to a prescribed zone of the material and whereby the sealing agent with the low melting point will melt when the contents of the package are heated.

In U.S. Pat. No. 4,874,620 entitled “Microwaveable Package Incorporating Controlled Venting”, a microwaveable package that employs vent channels between adhered laminates, whereby the vent channels are created by the patterned application of adhesive between an inner ply and an intermediate ply, thereby creating vent channels between the plys.

In U.S. Patent Application No. 2007/0087096 A1 entitled “Packaging Material and Method For Microwave and Steam Cooking of Food Products”, a packaging device is disclosed that allows for the distribution, storage and cooking of food products. The packaging device discloses a venting system whereby the vents are initially sealed but the seal is broken upon reaching a particular level of pressure within the package during heating or cooking.

It is desirable to provide a microwaveable package for food products that permits the continuous venting of the package through vent portions during the heating or cooking process in a microwave oven. Desirably, such a package is manufactured from packaging laminates having a heat sealable plastic layer. Appropriate packaging laminates do not require modification or alteration of the laminates in the area of the vents, and also permit one to use the package for containing the food during the heating or cooking of the food within the package.

### SUMMARY OF THE INVENTION

An object of the present invention is to provide an improved microwaveable package.

In accordance with one aspect of the present invention, there is provided a package for containing food to be heated in a microwave oven, said package comprising a front panel and a back panel, said package being formed from a continuous laminate structure, said laminate structure having an array of apertures through its thickness, said apertures being spaced a predetermined distance apart longitudinally along at least one of said front and back panels, said apertures providing vents to allow steam and/or pressure from inside said package to vent to the exterior of the package during heating of the food in the microwave oven.

In accordance with another aspect of the present invention, there is provided a package for containing food to be heated in a microwave oven, said package comprising a front panel and a back panel, said package being formed from a continuous laminate structure wherein the front panel has a top edge and a bottom edge, and the back panel has a top edge and a bottom edge, wherein the top edge of front panel is heat sealed to the top edge of the back panel and the bottom edge of the front panel is heat sealed to the bottom edge of the back panel, said laminate structure having an array of perforations through a section of the top edge of the front panel and the top edge of the back panel, said perforations oriented relative to each other horizontally but below the sealed top edges, said array of perforations forming vents allowing steam and/or pressure from inside said package to vent to the exterior of the package, wherein venting of said package occurs during heating.

In accordance with another aspect of the present invention, there is provided a package for containing food to be heated in a microwave oven, said package comprising a front panel, a back panel, a bottom gusset, two lateral sealed edges sealing the front and back panels together to seal food inside the package, said package being formed from a laminate structure, said sealed edges having a plurality of vented channels therethrough, said plurality of vented channels allowing steam and/or pressure from inside said package to vent to the exterior of the package, wherein said venting of said package occurs during heating.

Advantages of the present invention include the convenience, for a consumer, of using the same microwaveable package in which food items are purchased to contain the food during heating and/or cooking of the food in a microwave oven. The manufacturer of packages according to the invention also obtains the advantage of using laminates to make the package without alteration or modification of the laminate material being required.

### BRIEF DESCRIPTION OF THE DRAWINGS

Further features and advantages of the present invention will become apparent from the following description of embodiments thereof, presented by way of example only and by reference to the accompanying drawings, wherein:

FIG. 1 illustrates a perspective view of a microwaveable package with needle holes along a panel;

FIG. 2 illustrates a perspective view of the microwaveable package shown in FIG. 1 in an upright position;

FIG. 3 illustrates packaging material with needle holes before being formed into the package of FIGS. 1 and 2;

FIG. 4 illustrates a perspective view of a microwaveable package with slits along a panel in an upright position containing food;

FIG. 5 illustrates packaging material with slits before it is formed into the package of FIG. 4;

FIG. 6 illustrates a perspective view of a microwaveable package with perforations through the top edges of the panels;

FIG. 7 illustrates a perspective view of a microwaveable package in a pillow pack format with perforations through the top edges of the panels; and

FIG. 8 illustrates a perspective view of a microwaveable package in a bottom gusseted format with engineered side channels.

### DETAILED DESCRIPTION OF EMBODIMENTS OF THE INVENTION

This invention provides for a package for food items, such as vegetables, pasta dishes and other food products, where the packages contain the food items when they are sold to consumers. The packaged food may be sold fresh, frozen or refrigerated, and is typically distributed to retail stores for subsequent sale to the public. The packages of the invention are designed not only to contain the food during distribution, but also to contain the food while the food is cooked or heated in a microwave oven, thereby providing the consumer with the convenience of cooking the food in the same package in which it is purchased, without the inconvenience of opening the package, removing the food and using another container for heating or cooking the food.

The package provides for controlled venting of any pressure or steam that is generated within the package during the heating process in a microwave oven in order to ensure that such steam or pressure is released, preferably without bursting or otherwise substantially opening the structured package, until the package is physically opened by the consumer.

This invention provides for a structured package comprising a combination of laminates made from materials that are suitable for both storing the food items in their fresh or frozen states, and also for a microwave cooking application.

The packaging material is made of a multi-layer lamination, and in one embodiment, the package is made of a two-layer lamination with an inner and outer layer that are joined together with adhesive.

The top or outer layer is typically clear and typically made of polyester or polypropylene. The outer layer is typically clear to allow the consumer to view any ink design on the package, beneath the outer layer, as described hereafter.

The bottom or inner layer is typically white or clear and is a sealant film that is typically made of polyethylene or polypropylene. Polypropylene is suitable to withstand the heat generated in the microwave oven when in contact with selected foods, such as vegetables, pasta dishes and entrée type meals. The inner layer may be generally composed of a co-extruded material, two or more layers, or a mono structure. The inner layer will be heat sealable since it will be used to seal the package closed at the edges. The package is normally heat sealed into closure after the package has been filed with its contents. Heat sealing occurs when pressure is applied by mechanical force, typically by components of a vertical form, fill and seal (“VFFS”) machine, which is known in the art.

Ink is frequently used between the outer and inner layers. The ink will be applied to create a visual display to the consumer, and the ink design is frequently multicoloured to present information and advertising to the consumer about the product contained inside the package.

The package or bag of the present invention may be of any suitable size and shape to accommodate the food to be packaged.

The package is provided with vent apertures adapted to permit the venting of steam and pressure generated during heating and/or cooking the food. The vents may be of various sizes, shapes and orientations as further described hereafter. Since the packages of this invention are provided with the vent apertures, the packages are not intended to contain foods that require storage in a 100% sealed package. However, fresh and frozen foods typically require packages that have some form of openings, since the packages may be packed in boxes more efficiently if air is not trapped within the package.

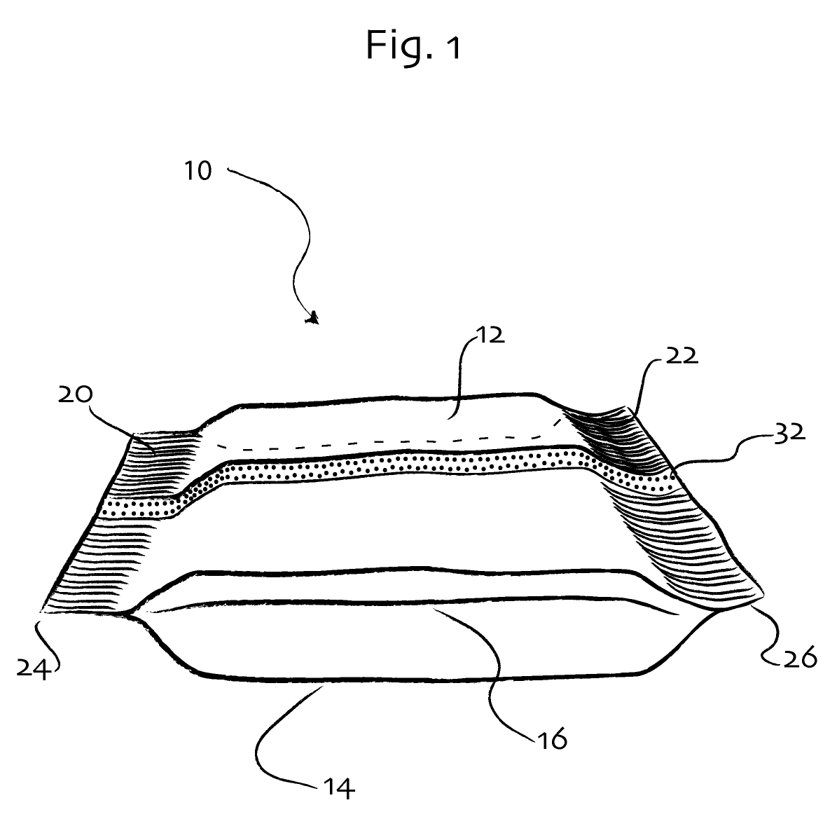

Referring to FIG. 1, there is illustrated a package 10 in accordance with the present invention. The package 10 is illustrated in a horizontal configuration, with a front panel 12, a back panel 14, and opposing side gussets 16. The packaging material preferably comprises an inner layer and outer layer, as described above. The front panel 12 has two edges 20 and 22 at either end of the front panel 12. The back panel 14 has two edges 24 and 26 at either end of the back panel 14. As shown, the edge 24 of back panel 14 is joined to the edge 20 of front panel 12, and the edge 26 of back panel 14 is joined to the edge 22 of front panel 12. The package has two opposing side gussets 16, with one of them shown in FIG. 1. Each side gusset 16 is formed between the front panel 12 and back panel 14, and each side gusset 16 is an inwardly folded piece of packaging material disposed between the front panel 12 and back panel 14.

Edge 20 of front panel 12 joins edge 24 of back panel 14 in a conventional manner known in the art whereby the inner layers of the laminate material are heat sealed together, resulting in the edges being sealed together and enclosing a food item within the package. Edge 22 of front panel 12 joins edge 26 of back panel 16 in a similar fashion. In addition, in order to enhance the heat sealing characteristics of the package in the side gusset areas, the outer layer of the packaging material may optionally be heat sealable, allowing the front panel 12 and back panel 14 and the gusset edges to be joined together, by pressure and heat being applied to the top and bottom edges during formation on the package on the VFFS machine, thereby closing the edges 20 to 24 and 22 to 26 in the proximity of the side gussets 16. By using a sealable outer layer, the side gussets may be tacked or sealed together at the top and bottom edges.

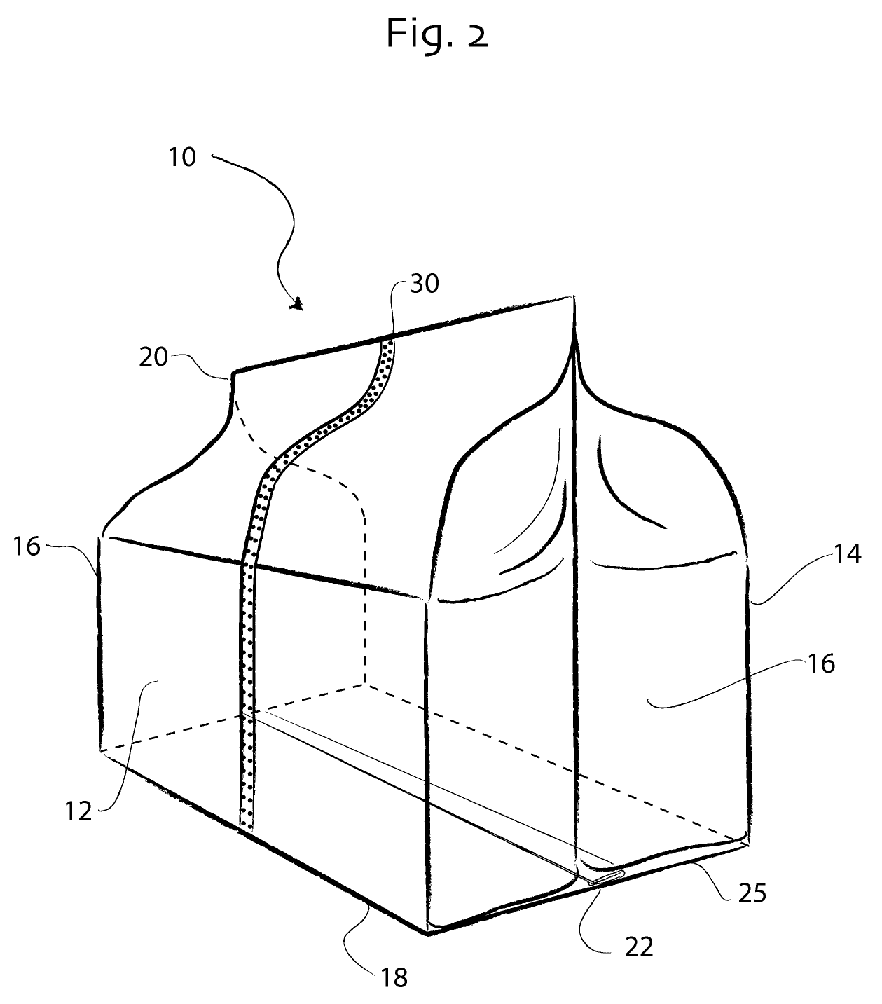

The package 10 is typically made on a VFFS machine, which is known in the art. The package is typically made by wrapping the packaging material around a forming tube. As shown, the packages are symmetrical and when food is placed inside the package, the package may be stood vertically, as shown in FIG. 2, resulting in the food collecting at one end of the package whereby the weight of the food causes the edge 22 to be folded over the edge 26 as the food rests on the front panel 12 and back panel 14 that now form a bottom section 25 to the package.

As a food item in the package 10 is heated in the microwave oven, pressure and steam are generated within the package by the cooking or heating process. In order to permit release of the steam or pressure within the package and prevent rupture of the package, apertures or vents are provided in the package.

As shown in FIGS. 1 and 2, the package 10 has holes or perforations 30 disposed in a vent strip that runs along the front panel 12 and between the side gussets 16. FIG. 2 shows the package 10, as shown in FIG. 1, rotated by 90 degrees, with food inside the package collected towards the lower edge. The holes 30 may also run along the back panel 14. Having the holes run along the back panel is often preferred to avoid interfering with the visual pattern that is displayed on the front panel. The holes 30 permit the release of pressure and steam from within the package when the package is inserted in a microwave oven and the food product within the package is heated.

The holes 30 preferably may be formed in the packaging material by needles that attach to wheels, in a known manner, to slitter machinery. “Slitting” is a known term that refers to trimming the packaging material after the inner and outer layers of the packaging material have been bonded together, via the adhesive, and allowed to cure on a roll before packages are formed. Preferably, 18 or 21 gauge needles are implemented to form vents but the diameter size can vary to match the requirements of the type of food to be packaged and subsequently heated or cooked in a microwave oven. The vents are also sized in accordance with the volume of the package and the volume of the food to permit pressure build-up to aid in the heating or cooking process.

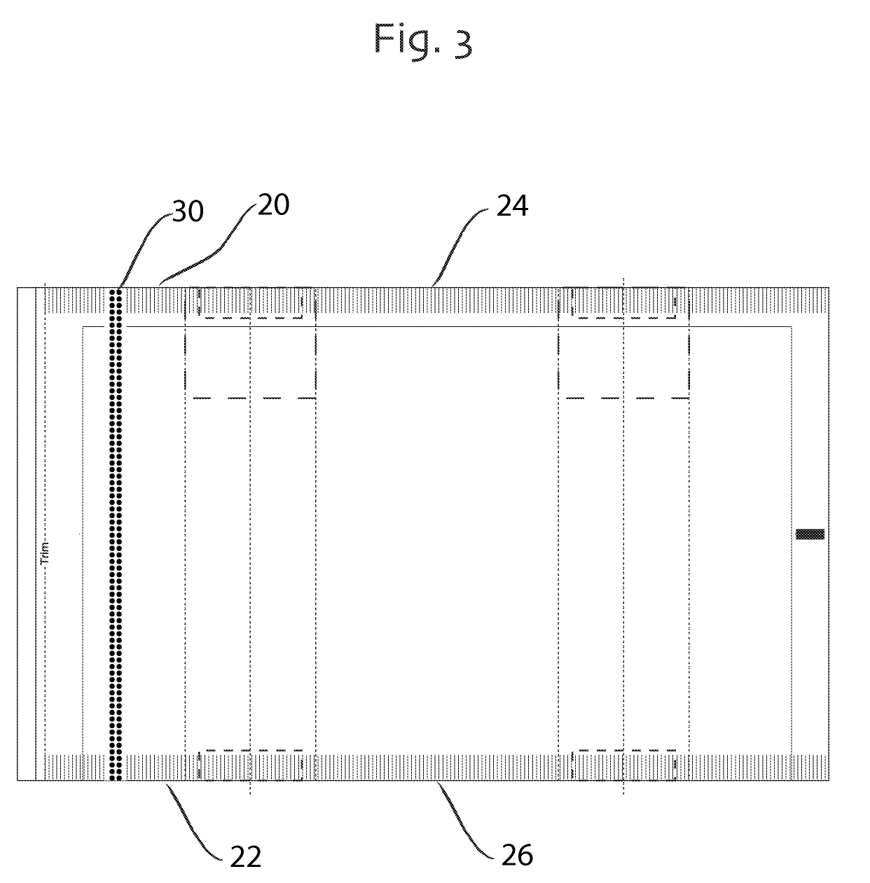

With a VFFS package forming machine, a roll of packaging material is used to create a multiple number of packages. The roll of packaging material comprises a multiple number of templates of packaging material, so each template of packaging material is used to create a package with the next template being readily available to create the next package. FIG. 3 illustrates a template of the packaging material as a continuous laminate structure with holes 30 before it is formed into a package, as illustrated in FIGS. 1 and 2, on a VFFS machine.

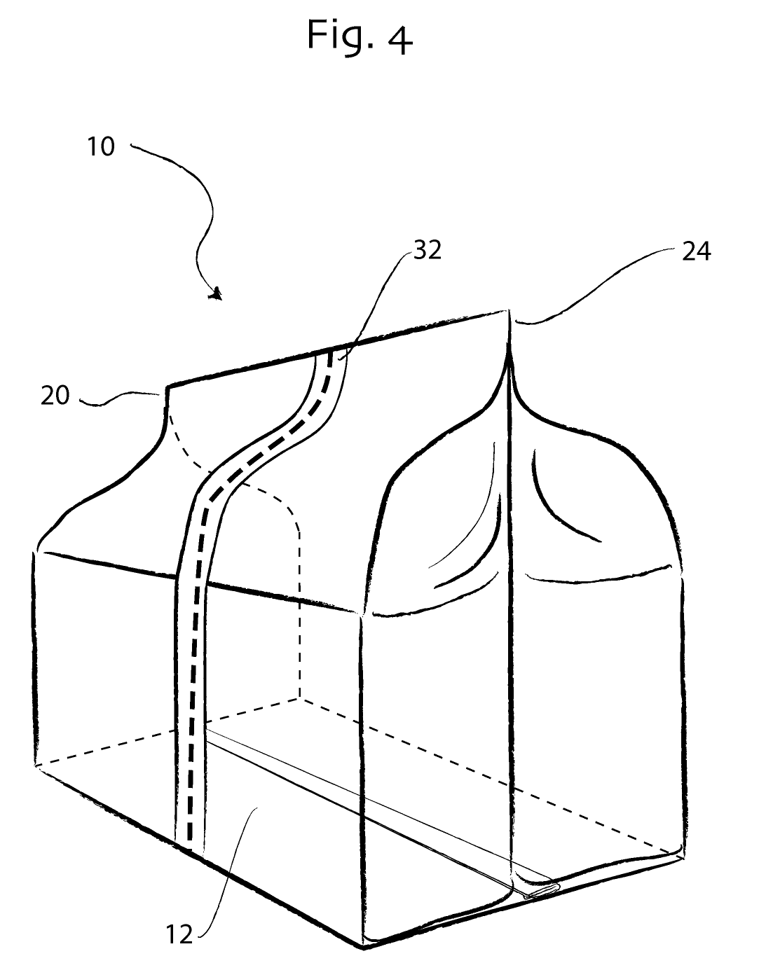

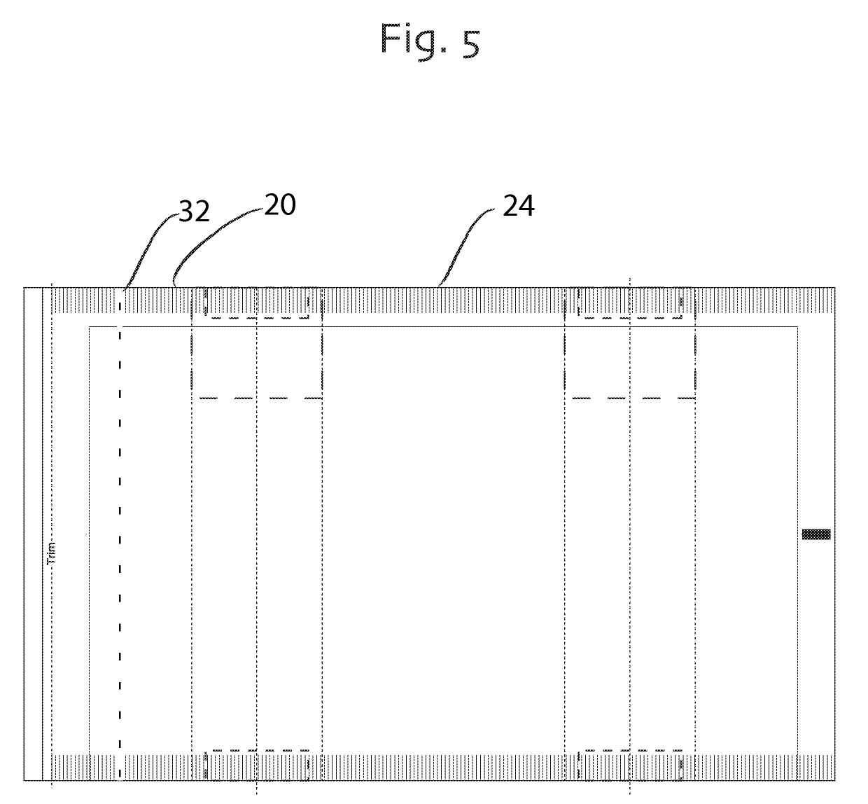

Alternatively, the venting system may be formed by providing a series of slits in the packaging material before the packages are formed. FIG. 4 illustrates a package 10 with slits 32 disposed in a vent strip that runs along the front panel 12 and between the side gussets. Slits 32 are preferably formed in the packaging material by blades that attach to the wheels described above. Preferably the slits are 0.125 inches to 0.25 inches long, and can be customized to the requirements of the cooking process, the food type and the volume of the package and food. As indicated above, the slits may preferably run along the back panel, to avoid interfering with the visual pattern or text that is displayed on the front panel. FIG. 5 illustrates a template of the packaging material as a continuous laminate structure with slits 30 before it is formed on a VFFS machine into the package of FIG. 1 or 2.

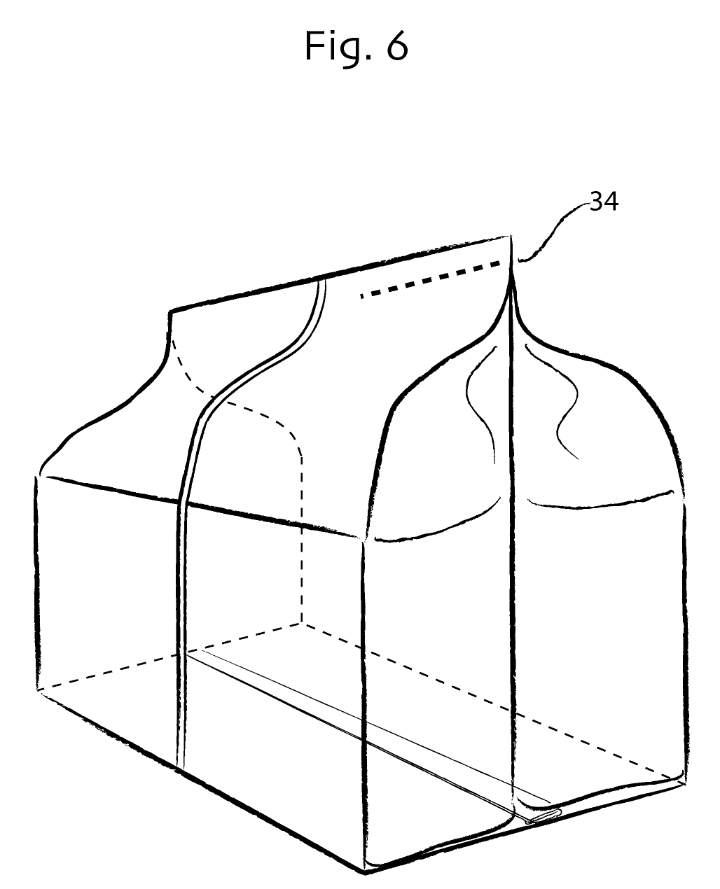

Alternatively, vents can be created by a perforating knife, also called a “perfing” knife, which typically attaches to the sealing bar mechanism of a VFFS machine. In this embodiment, the perfing knives are attached to the sealing bar mechanism of a VFFS machine to create an “Easy Open” feature, whereby the package may be readily opened along a line of perforations since the line of perforations provides a tear away feature. FIG. 6 illustrates a stand-up package 10 with a vent system of perforations 34 generally parallel to the top edges 20 and 24 that are sealed together. The sealed edges join the front panel 12 and the back panel 14. Perforations 34 are formed with a predetermined length and at a predetermined distance apart. Similar to the holes 30, shown in FIGS. 1 and 2, the perforations 34 allow steam to escape from within the package during the heating or cooking process.

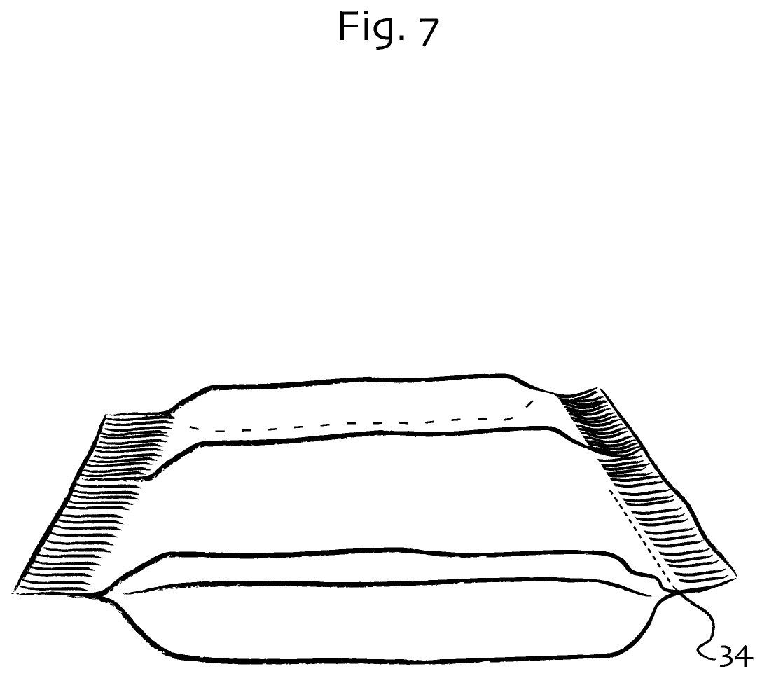

Packages in accordance with the invention may also take the form of a pillow pack design, which does not have sealed side gussets, in contrast to a stand-up pouch design, as shown in FIG. 7. A vent system of perforations 34 may be provided along a portion of the edges but inwardly of the sealed area. Such a pillow pack could also be provided with vents that are apertures, preferably perforations, holes or slits, disposed in a strip that runs along the front or back panel, similar to the manner described above with reference to the side gusted packages shown in FIGS. 1 and 2. In the pillow pack configuration, the packaging material will still be a multi-laminate structure, as described above. The outer layer of laminate is preferably polyester and not heat sealable, because there is no need to seal any side gussets together.

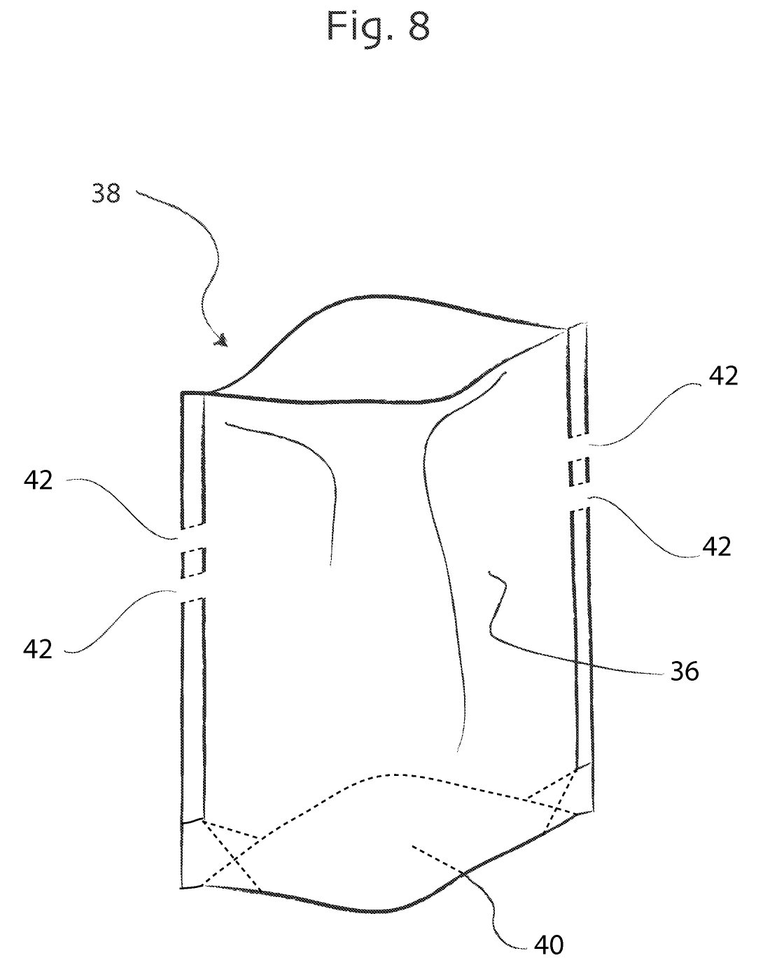

A further embodiment of the package may take the form of a bottom gusted package of known design, as shown in FIG. 8. This type of package is pre-formed since the packages are made from a continuous laminate structure but they are not filled with food at the same time that the package is constructed. This type of package does not have side gussets but has a front panel 36, a back panel 38, and a bottom gusset 40. Each panel is made from the laminate material structure described above. The inner layer is typically white or clear and is a sealant film that is typically made of polyethylene or polypropylene. The side edges of the panels are sealed together by a seal bar, which is a known device that applies pressure and heat to the side edges. However, by removing a section from the seal bar in specific areas, the seal bar will not apply pressure to those areas of the side edges. As a result, the specific areas where pressure has not been applied remain unsealed, thereby creating open, unsealed channels 42. After the package is formed in this manner, it can be filled with food and sealed at the top edges of the front and back panels in a known manner.

When the package is placed in a microwave oven for heating, the unsealed channels then act as a vent or escape for the pressure and steam that is generated as the food item is heated.

The unsealed channels 42 are sized to permit venting of the food but are small enough to prevent any loss of food product from the package during storage, and they are also small enough to prevent any interference with the enclosed food from outside the package. For example, the unsealed channels would not be large enough to permit a person to reach into the package with their fingers or to insert other contaminants.

It is believed that the operation and construction of the present invention will be apparent from the foregoing description. The invention is not limited to any embodiment herein described and includes all modification within the purview of a skilled person, and any such modifications should be considered within the scope of the appended claims. Features which are not specifically or explicitly described may be included according to the present invention without deviating from its scope.

1. A package for containing food to be heated in a microwave oven, said package comprising a front panel and a back panel, said package being formed from a continuous laminate structure, said laminate structure having an array of apertures through its thickness, said apertures being spaced a predetermined distance apart longitudinally along at least one of said front and back panels, said apertures providing vents to allow steam and/or pressure from inside said package to vent to the exterior of the package during heating of the food in the microwave oven.

2. The package of claim 1 wherein the package is formed on a vertical form and fill machine.

3. The package of claim 2 wherein the apertures are formed by perforating the laminate structure before the package is formed.

4. The package of claim 3 wherein the apertures are holes.

5. The package of claim 3 wherein the apertures are slits.

6. The package of claim 2 further comprising two inwardly folded gusseted side panels with each gusseted side panel joined to the front and back panels by heat sealing.

7. The package of claim 6 wherein the apertures are formed by perforating the laminate structure before the package is formed.

8. The package of claim 7 wherein the apertures are holes.

9. The package of claim 7 wherein the apertures are slits.

10. The package of claim 2 wherein the front panel has a first edge and a second edge, and the back panel has a first edge and a second edge, wherein the first edge of front panel is heat sealed to the first edge of the back panel and the second edge of the front panel is heat sealed to the second edge of the back panel, to seal food inside the package.

11. The package of claim 10 wherein the apertures are formed by perforating the laminate structure before the package is formed.

12. The package of claim 10 wherein the apertures are holes.

13. The package of claim 10 wherein the apertures are slits.

14. A package for containing food to be heated in a microwave oven, said package comprising a front panel and a back panel, said package being formed from a continuous laminate structure wherein the front panel has a top edge and a bottom edge, and the back panel has a top edge and a bottom edge, wherein the top edge of front panel is heat sealed to the top edge of the back panel and the bottom edge of the front panel is heat sealed to the bottom edge of the back panel, said laminate structure having an array of perforations through a section of the top edge of the front panel and the top edge of the back panel, said perforations oriented relative to each other horizontally but below the sealed top edges, said array of perforations forming vents allowing steam and/or pressure from inside said package to vent to the exterior of the package, wherein venting of said package occurs during heating.

15. The package of claim 14 further comprising two inwardly folded gusseted side panels with each gusseted side panel joined to the front and back panels by heat sealing.

16. A package for containing food to be heated in a microwave oven, said package comprising a front panel, a back panel, a bottom gusset, two lateral sealed edges sealing the front and back panels together to seal food inside the package, said package being formed from a laminate structure, said sealed edges having a plurality of vented channels therethrough, said plurality of vented channels allowing steam and/or pressure from inside said package to vent to the exterior of the package, wherein said venting of said package occurs during heating.
